(19) United States
(12) Patent Application Publication
(10) Pub. No.: US 2025/0007555 A1
(43) Pub. Date: Jan. 2, 2025

(54) Method for the recovery of analog backscattered information

(71) Applicants: GEORGIOS VOUGIOUKAS, UNTERHACHING (DE); AGGELOS BLETSAS, CHANIA (GR)

(72) Inventors: GEORGIOS VOUGIOUKAS, UNTERHACHING (DE); AGGELOS BLETSAS, CHANIA (GR)

(21) Appl. No.: 18/216,272

(22) Filed: Jun. 29, 2023

(51) Int. Cl. H04B 1/54; H04B 7/22

(52) U.S. Cl. CPC H04B 1/54; H04B 7/22

(57) ABSTRACT

Method for receiving and recovering analog information that is modulated on a radio frequency carrier that impinges on a backscattering antenna, using commercially available, digital, embedded, radio receivers. The analog information is modulated by means of an impedance modulator altering the impedance of said backscattering antenna.

### TECHNICAL FIELD

Aspects herein relate generally to ultra-low-power wireless communication by means of reflection of signals. More particularly, aspects herein relate to a method for receiving an analog, information-bearing signal that modulates a radio frequency carrier signal that impinges on an antenna. The modulation of said analog, information-bearing signal is performed by an impedance modulator that modulates the impedance of said antenna. The method disclosed in the present invention relates to recovering the backscattered signal from said antenna and recovering the analog information that is modulated on it, using commercial, digital, embedded radio receiver devices.

### BACKGROUND OF THE INVENTION

Recent advances in the field of wireless communication by means of reflecting a RF signal, have enabled the development of ultra-low-power, wireless sensing devices [Bletsas et al 18]. A sensing device can transmit information related to a measured quantity without the need for a power amplifier or a mixer. An externally provided carrier signal impinging on the antenna of said sensing device, can be modulated using backscatter radio principles [Stockman 48].

In a conventional transmitting device, a baseband signal containing analog or digital information is upconverted using a high frequency oscillator and a mixer. Then, a gain stage (e.g., a power amplifier) amplifies the signal. The amplified signal subsequently drives an antenna that radiates said signal into the environment. Using backscatter radio principles, in a backscattering device, an appropriately designed information-bearing baseband signal, controls an impedance modulator that is coupled to an antenna. Provided RF illumination to said antenna and by appropriate modulation of said antenna's impedance, reflections occur that contain said information, which propagate and can be received by an appropriate device.

Recent studies and inventions have demonstrated that low-complexity circuits can exploit either modulated ambient [Smith et al 13], [Smith et al 17], [Bletsas et al 17], [Vougioukas et al 19] or unmodulated [Reynolds et al 20] illumination signals to convey analog or digital information towards an appropriate receiver. Analog backscattering techniques are used to convey sensor information towards software defined [Bletsas et al 13] or analog radio receivers [Vougioukas et al 19]. Information of a sensor modulates the frequency of a baseband waveform that in turn controls an impedance modulator resulting in the backscattering of analog information (i.e., said frequency) [Baldwin et al 78], [Bletsas et al 13b], [Bletsas et al 14].

Backscattering devices for transmitting digital information in a packet format, can transmit their information under modulated or unmodulated illumination by a carrier [Bletsas et al 08], [Smith et al 13], [Bletsas et al 14]. Appropriate receivers can either be designed using software defined radios and accompanying demodulation and detection software [Bletsas et al 14] or appropriately configured embedded radio systems [Bletsas et al 16], [Reynolds et al 20].

A need exists to provide a method for wirelessly interfacing backscattering devices that transmit analog frequency information, with digital packet-based, embedded radio systems. That way the need for a dedicated analog receiver or a software defined radio receiver with accompanying demodulation software (amplitude demodulation, frequency demodulation, phase demodulation or combinations thereof, is omitted in favor for the lower-cost alternative of an embedded receiver module.

The inventors have devised a method for receiving analog information that is frequency modulated (and transmitted by a backscattering device) from an embedded radio module, designed for digitally modulated signals. More specifically this invention offers a method for estimating the fundamental frequency of a signal that modulates the frequency of subcarriers, generated by means of backscattering a continuous wave signal impinging on the antenna of a backscattering device. Any commercially available embedded radio module/receiver of FSK or OOK modulated signals, able to configure the communication bit rate and the packet structure by means of external or embedded control, can be used for the proposed estimation method.

### SUMMARY OF THE INVENTION

The objective of the present invention is achieved by an embedded receiver of FSK or OOK modulated signals connected to an external or embedded controller able to control and configure said receiver. The external or embedded controller sequentially configures the embedded receiver to a bit rate from a set of bit rates. For each bit rate, said controller polls the receiver for a successful detection of a packet or parts of a packet of data. If a packet or parts of a packet are detected, the controller reports the target bit rate for which the detection occurred. The objective is also achieved in conjunction with a backscattering device that is illuminated by an externally provided unmodulated signal. As a result of its backscattering operation, the backscattering device generates subcarriers that are frequency modulated by a signal whose frequency is estimated by dividing said target bit rate by two.

### BRIEF DESCRIPTION OF THE DRAWING

FIG. 1 is a system view of a backscattering device transmitting frequency information to a digital embedded receiver under illumination from unmodulated radio frequency signals, according to an aspect of the present invention;

FIG. 2 is a block level view of a backscattering device that transmits frequency modulated signals;

FIG. 3 is block level view of the operation of a backscattering device transmitting frequency modulated subcarriers at a set of frequencies according to an aspect of the present invention.

FIG. 4 is a block level view of the operation of a backscattering device transmitting frequency modulated subcarriers at another set of frequency according to an aspect of the present invention.

FIG. 5 is a method for estimating the fundamental frequency of the squarewave applied to the backscattering device depicted in FIG. 2, according to an aspect of the present invention.

### DETAILED DESCRIPTION OF THE INVENTION

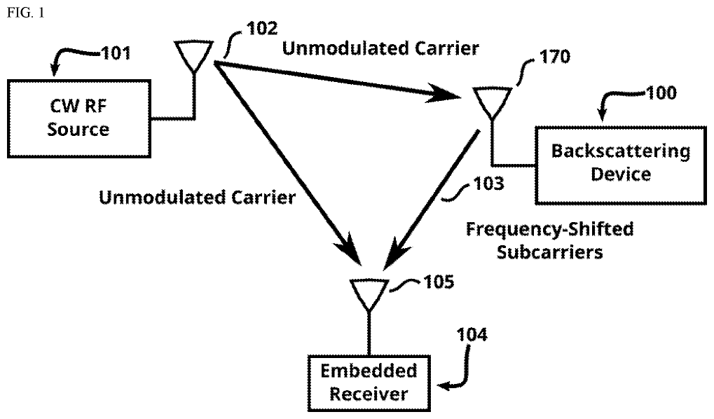

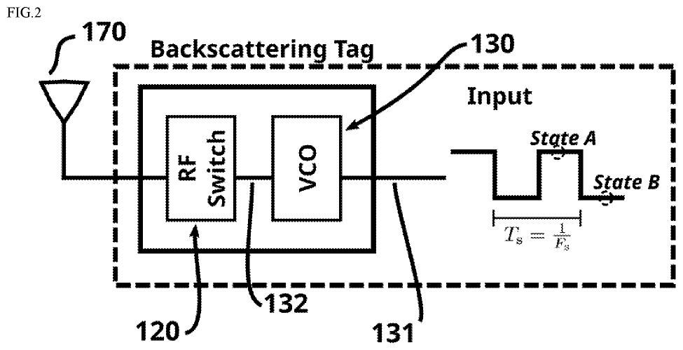

FIG. 1 depicts a system level view of an example deployment including a source 101 of unmodulated Radio Frequency (RF) signals, a backscattering device 100 and an embedded receiver 104 according to examples of the invention. Backscattering device 100 is further depicted in FIG. 2. Backscattering device 100 may comprise of an RF switch 120 connected to an antenna 170, a voltage controlled oscillator (VCO) 130 and an input squarewave signal 131 that controls the voltage controlled oscillator. In some examples, a circuit within the backscattering device may produce input signal 131.

Voltage controlled oscillator 130 produces a squarewave signal 132 having a variable fundamental frequency that is configured according to the squarewave input signal 131. In an example implementation, the squarewave input signal 131 has two distinct states, state A and state B; voltage controlled oscillator 130 produces the squarewave signal 132 having a fundamental frequency equal to F_{H} when the squarewave input signal 131 attains state A; voltage controlled oscillator 130 produces the squarewave signal 132 having a fundamental frequency equal to F_{L} when the squarewave input signal 131 attains state B.

RF switch 120 implements an impedance modulator, modulating the termination impedance of the antenna 170. In an example implementation, RF switch 120 alters the termination impedance of antenna 170 between two impedance loads according to the squarewave signal 132 of the voltage controlled oscillator 130.

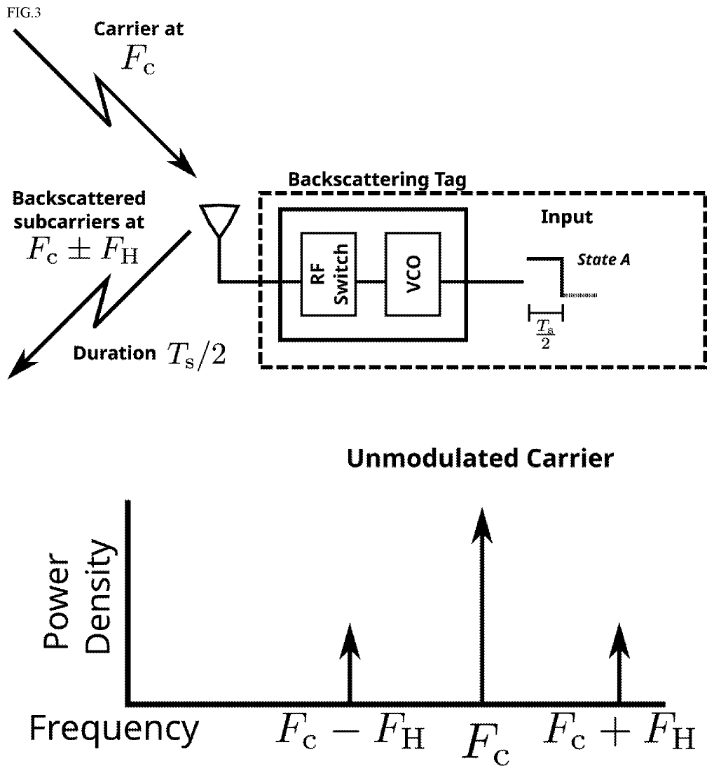

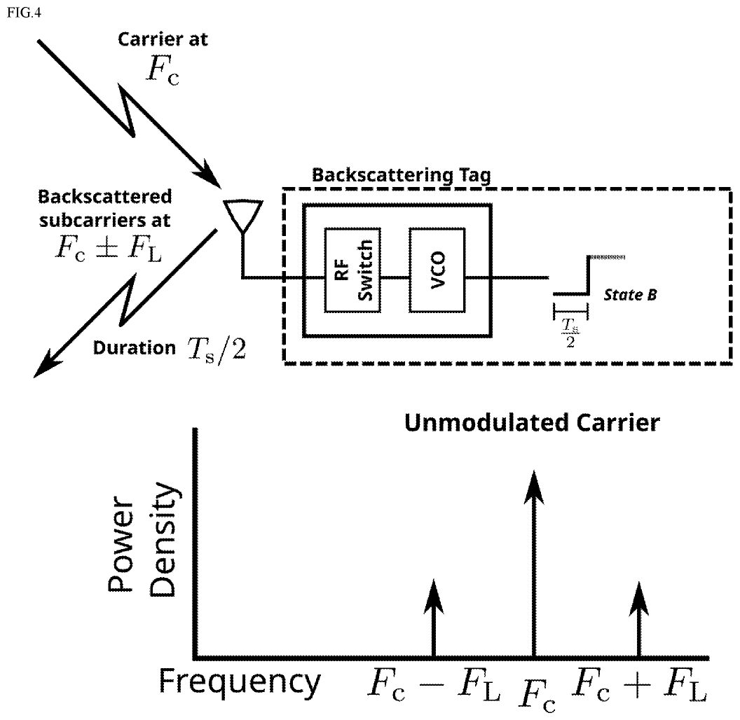

The source of unmodulated RF signals emits an unmodulated RF carrier signal 102 having carrier at a frequency of F_{C}. The unmodulated carrier signal 102 impinges on the antenna 170 of the backscattering device 100. In an example implementation of the backscattering device 100, due to its backscattering operation, subcarriers 103 will be transmitted at F_{C}+F_{H} when the squarewave input signal 131 attains state A, or at F_{C}+F_{L} when the squarewave input signal 131 attains state B. Backscattering device 100 transmits the subcarriers 103 at F_{C}+F_{H} or F_{C}+F_{L}, each for a duration of T_{S}/2 seconds. Duration T_{S}/2 is the duration of each state of the squarewave input signal 131. An example of the process is depicted in FIG. 3 and FIG. 4.

In an example implementation of the deployment depicted in FIG. 1, embedded receiver 104 is configured to receive binary FSK modulated signals attaining a specific packet structure. Said packet contains bits that have a specific bit duration: the bit duration is equal to the inverse of the bit rate that said packet's bits adhere to. Said packet consists of a mandatory preamble sequence of alternating bits, followed by a synchronization sequence consisting of alternating bits and a sequence of payload bits of arbitrary value. The configuration of the embedded receiver is performed by an external or an embedded controller. In one example of the deployment, the configuration is performed by a microcontroller or a microprocessor.

The embedded receiver 104 is further configured to receive binary-FSK modulated signals, for which the FSK subcarrier corresponding to signaling logic zero is located at a frequency of F_{C}+F_{L} and FSK subcarrier corresponding to signaling logic one is located at a frequency of F_{C}+F_{H}. In another example of the invention, the embedded receiver 104 can be configured to receive binary-FSK modulated signals, for which the FSK subcarrier corresponding to signaling logic zero is located at a frequency of F_{C}−F_{H} and FSK subcarrier corresponding to signaling logic one is located at a frequency of F_{C}−F_{L}.

In other configurations of the embedded receiver 104, frequency deviation and receiver bandwidth adjustments can be made to increase the reception performance. Said adjustments are performed while also tuning the F_{L} and F_{H} frequencies in the VCO 130 of the backscattering device 100.

Due to the state alternation of the squarewave input 131 in backscattering device 100, the upper sideband subcarriers transmitted by the backscattering device 100 alternatively at F_{C}+F_{L} or F_{C}+F_{H}, or the lower sideband subcarriers transmitted by the backscattering device 100 alternatively at F_{C}−F_{H} or F_{C}−F_{L}, resemble a binary FSK-modulated signal that is modulated by a continuous sequence of alternating bits. If the embedded receiver 104 is configured to receive packets having a bit duration of T_{S}/2, then the embedded receiver 104 will report the detection of a packet or parts of a packet containing a continuous stream of alternating bits.

The aforementioned detection occurs only when the packet structure is configured at the embedded receiver to include a preamble sequence of alternating bits. The transmissions of the backscattering device 100 resemble a digitally modulated binary FSK packet transmission where the contents of said packets include a sequence of continuously alternating bits. Thus, in order for the embedded receiver 104 to successfully detect the FSK-resembling transmission, said embedded receiver 104 must be configured to detect such a packet of alternating bits. Thus the preamble sequence expected by the embedded receiver at the start of a packet, must be configured to be a preamble sequence of alternating bits.

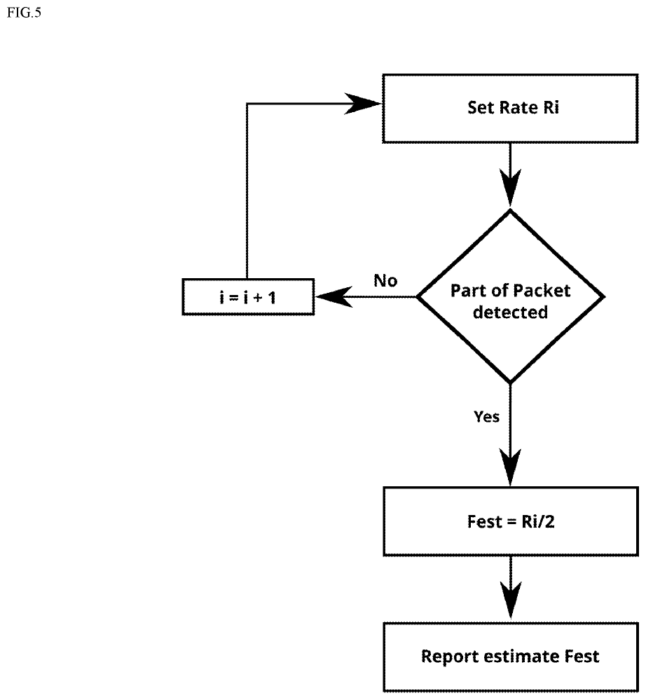

FIG. 5 depicts a flow graph of a method for estimating the frequency F_{S}=1/T_{S} of the squarewave input signal 131, according to an aspect of the present invention. The controller configures sequentially the bit rate of the embedded receiver 104, among a plurality of achievable bit rates. For each bit rate from the plurality of bit rates that the embedded receiver 104 is configured, the controller polls the embedded receiver 104 for the event of successful detection of a packet or parts of a packet adhering to the configured packet structure and bit rate. The successful detection of a packet or parts of a packet includes but is not limited to the successful detection of said preamble sequence or the detection of said synchronization sequence or combinations of those sequences thereof.

When a successful detection event is logged by the controller, the controller reports the bit rate from the plurality of bit rates for which the successful detection event at the receiver occurred. Due to the resemblance of the backscattered subcarriers/signal 103 with binary FSK modulated signals, the frequency of the squarewave input signal 131 can be then estimated by dividing the bit rate for which successful detection occurred by 2.

In another example implementation, the embedded receiver 104 can be configured to demodulate and detect OOK modulated signals following the same packet structure described in previous implementation examples. In that example implementation of the invention, one of either of the fundamental frequencies (F_{H} or F_{L}) of the square wave 132, must be equal to zero. In another example implementation, one of either of F_{H} or F_{L}, can be set to zero even if the embedded receiver 104 is configured for the reception of FSK modulated signals.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention as claimed.

### REFERENCES

[Stockman 48] H. Stockman. “Communication by means of reflected power.” Proc. IRE, vol. 36, no. 10. pp. 1196-124 October 1948.
[Baldwin et al 78] Interrogation and detection system. U.S. Pat. No. 4,075,632A.
[Bletsas et al 08] G. Vannucci. A. Bletsas, and D. Leigh. “A software-defined radio system for backscatter sensor networks.” IEEE Trans. Wireless Commun., vol. 7, no. 6. pp. 2170-2179 June 2008.
[Bletsas et al 14] J. Kimionis. A. Bletsas, and J. N. Sahalos. “Increased range bistatic scatter radio.” IEEE Trans. Commun., vol. 62, no. 3, pp. 1091-114 March 2014.
[Smith et al 13] V. Liu. A. Parks. V. Talla. S. Gollakota. D. Wetherall. and J. R. Smith. “Ambient backscatter: Wireless communication out of thin air.” in ACM SIGCOMM. Hong Kong. China. 2013. pp. 39-50.
[Bletsas et al 13] C. Konstantopoulos. E. Kampianakis. E. Koutroulis, and A. Bletsas. “Wireless sensor node for backscattering electrical signals generated by plants.” in Proc. IEEE Sensors Conf. Baltimore, MD. USA. November 2013.
[Bletsas et al 13b] E. Kampianakis, J. Kimionis, K. Tountas, C. Konstantopoulos, E. Koutroulis, and A. Bletsas, “Backscatter sensor network for extended ranges and low cost with frequency modulators: Application on wireless humidity sensing.” in Proc. IEEE Sensors Conf. Baltimore, MD. USA. November 2013.
[Bletsas et al 14] S. N. Daskalakis. S. D. Assimonis. E. Kampianakis, and A. Bletsas. “Soil moisture wireless sensing with analog scatter radio, low power, ultra low cost and extended communication ranges.” in Proc. IEEE Sensors Conf., Valencia, Spain, November 2014, pp. 122-125.
[Bletsas et al 16] G. Vougioukas, S. N. Daskalakis and A. Bletsas, “Could battery-less scatter radio tags achieve 270-meter range?”, Proc. IEEE Wireless Power Transfer Conf., pp. 1-3, May 2016.
[Smith et al 17] A. Wang, V. Iyer, V. Talla. J. R. Smith, and S. Gollakota. “FM backscatter: Enabling connected cities and smart fabrics.” in USENIX Symposium on Networked Systems Design and Implementation, Boston, MA. USA, March 2017.
[Bletsas et al 17] G. Vougioukas and A. Bletsas. “24 μW 26 m range batteryless backscatter sensors with FM remodulation and selection diversity.” in Proc. IEEE RFID Techn. and Applications (RFID-TA), Warsaw, Polland, September 2017.
[Vougioukas et al 19] Ultra-low power and cost purely analog backscatter sensors with extended range smartphone/consumer electronics FM reception. U.S. Pat. No. 10,395,162 B1.
[Reynolds et al 20] Devices and methods for backscatter communication using one or more wireless communication protocols including Bluetooth low energy examples. U.S. Pat. No. 10,693,521 B2.
[Bletsas et al 18] A. Bletsas. P. N. Alevizos. and G. Vougioukas. “The art of signal processing in backscatter radio for μW (or less) internet of things: Intelligent signal processing and backscatter radio enabling batteryless connectivity.” IEEE Signal Processing Mag., vol. 35, no. 5. pp. 28-40, September 2018.

1) A method for estimating a fundamental frequency transmitted by a backscattering device comprising:
illuminating the antenna of the backscattering device with an unmodulated signal;
receiving the backscattered signal of the backscattering device using an embedded receiver of FSK or OOK modulated signals;
configuring the embedded receiver to detect a packet or parts of a packet having a structure of a sequence of alternating bits and a payload of arbitrary binary data;
configuring the embedded receiver to detect a packet or parts of a packet having a specific bit rate;
sequentially configuring the embedded receiver in a plurality of bit rates;
polling the embedded receiver for a detection of a packet or part of a packet for each bit rate from the plurality of bit rates;
acquiring a target bit rate from the plurality of bit rates for which a detection of a packet or part of a packet occurred;
estimating the fundamental frequency transmitted by the backscattering device by dividing the target bit rate by 2.

2) The method of claim 1 wherein the backscattering device modulates the impedance of an antenna using an impedance modulator controlled by a squarewave that is frequency modulated by a signal having the fundamental frequency.
